(19) United States
(12) Patent Application Publication
(10) Pub. No.: US 2026/0304321 A1
(43) Pub. Date: Oct. 1, 2026

(54) RATE MATCHING FOR MULTI-TONE LOW-POWER WAKE UP SIGNALS AND/OR MULTI-TONE LOW-POWER SYNCHRONIZATION SIGNALS

(71) Applicant: QUALCOMM INCORPORATED, San Diego, CA (US)

(72) Inventors: Abdelrahman Mohamed Ahmed Mohamed IBRAHIM, San Diego, CA (US); Ahmed ELSHAFIE, San Diego, CA (US); Yuchul KIM, San Diego, CA (US); Wei YANG, San Diego, CA (US); Chao WEI, Beijing (CN)

(21) Appl. No.: 19/475,740

(22) PCT Filed: May 19, 2023
(86) PCT No.: PCT/CN2023/095187

§ 371 Date: Oct. 15, 2025

(51) Int. Cl. H04W 52/02

(52) U.S. Cl. CPC H04W 52/0235

(57) ABSTRACT

Various aspects of the present disclosure generally relate to wireless communication. In some aspects, a user equipment (UE) may receive configuration information indicating a rate matching pattern associated with one of a multi-tone low-power wake up signal (LP-WUS) or a multi-tone low-power synchronization signal (LP-SS). The UE may decode a downlink communication based at least in part on the rate matching pattern associated with the one of the multi-tone LP-WUS or the multi-tone LP-SS. Numerous other aspects are described.

### FIELD OF THE DISCLOSURE

Aspects of the present disclosure generally relate to wireless communication and to techniques and apparatuses for rate matching for multi-tone low-power wake up signals and/or multi-tone low-power synchronization signals.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving configuration information indicating a rate matching pattern associated with one of a multi-tone low-power wake up signal (LP-WUS) or a multi-tone low-power synchronization signal (LP-SS). The method may include decoding a downlink communication based at least in part on the rate matching pattern associated with the one of the multi-tone LP-WUS or the multi-tone LP-SS.

Some aspects described herein relate to a method of wireless communication performed by a network node. The method may include transmitting, to a UE, configuration information indicating a rate matching pattern associated with one of a multi-tone LP-WUS or a multi-tone LP-SS. The method may include transmitting, to the UE, a downlink communication based at least in part on the rate matching pattern associated with the one of the multi-tone LP-WUS or the multi-tone LP-SS.

Some aspects described herein relate to a UE for wireless communication. The UE may include one or more memories and one or more processors coupled to the one or more memories. The one or more processors may be configured to receive configuration information indicating a rate matching pattern associated with one of a multi-tone LP-WUS or a multi-tone LP-SS. The one or more processors may be configured to decode a downlink communication based at least in part on the rate matching pattern associated with the one of the multi-tone LP-WUS or the multi-tone LP-SS.

Some aspects described herein relate to a network node for wireless communication. The network node may include one or more memories and one or more processors coupled to the one or more memories. The one or more processors may be configured to transmit, to a UE, configuration information indicating a rate matching pattern associated with one of a multi-tone LP-WUS or a multi-tone LP-SS. The one or more processors may be configured to transmit, to the UE, a downlink communication based at least in part on the rate matching pattern associated with the one of the multi-tone LP-WUS or the multi-tone LP-SS.

Some aspects described herein relate to a non-transitory computer-readable medium that stores a set of instructions for wireless communication by a UE. The set of instructions, when executed by one or more processors of the UE, may cause the UE to receive configuration information indicating a rate matching pattern associated with one of a multi-tone LP-WUS or a multi-tone LP-SS. The set of instructions, when executed by one or more processors of the UE, may cause the UE to decode a downlink communication based at least in part on the rate matching pattern associated with the one of the multi-tone LP-WUS or the multi-tone LP-SS.

Some aspects described herein relate to a non-transitory computer-readable medium that stores a set of instructions for wireless communication by a network node. The set of instructions, when executed by one or more processors of the network node, may cause the network node to transmit, to a UE, configuration information indicating a rate matching pattern associated with one of a multi-tone LP-WUS or a multi-tone LP-SS. The set of instructions, when executed by one or more processors of the network node, may cause the network node to transmit, to the UE, a downlink communication based at least in part on the rate matching pattern associated with the one of the multi-tone LP-WUS or the multi-tone LP-SS.

Some aspects described herein relate to an apparatus for wireless communication. The apparatus may include means for receiving configuration information indicating a rate matching pattern associated with one of a multi-tone LP-WUS or a multi-tone LP-SS. The apparatus may include means for decoding a downlink communication based at least in part on the rate matching pattern associated with the one of the multi-tone LP-WUS or the multi-tone LP-SS.

Some aspects described herein relate to an apparatus for wireless communication. The apparatus may include means for transmitting, to a UE, configuration information indicating a rate matching pattern associated with one of a multi-tone LP-WUS or a multi-tone LP-SS. The apparatus may include means for transmitting, to the UE, a downlink communication based at least in part on the rate matching pattern associated with the one of the multi-tone LP-WUS or the multi-tone LP-SS.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4B are diagrams illustrating an example associated with low-power wakeup signals (LP-WUSs) and/or low-power synchronization signals (LP-SSs), in accordance with the present disclosure.

FIGS. 4C and 4D show example waveforms that may be associated with multi-tone LP-WUSs and/or multi-tone LP-SSs.

FIG. 5 is a diagram of an example associated with rate matching for multi-tone LP-WUSs and/or LP-SSs, in accordance with the present disclosure.

FIG. 6 is a diagram illustrating an example process performed, for example, by a UE, in accordance with the present disclosure.

FIG. 7 is a diagram illustrating an example process performed, for example, by a network node, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

In some wireless communication systems, a user equipment (UE) may include multiple radios and/or receivers for communicating with a network node, such as a main radio for receiving normal wireless traffic, and a low-power wakeup receiver (LP-WUR) for receiving low-power signals, such as a low-power wakeup signal (LP-WUS), a low-power synchronization signal (LP-SS), or a similar low-power signal. In such systems, the UE may conserve power by entering a deep sleep mode when the UE is not actively transmitting or receiving data traffic while still maintaining synchronization with the network node via reception of one or more LP-SSs. Moreover, upon receiving an LP-WUS via the LP-WUR, which is indicative that the network node has downlink traffic to transmit to the UE, the UE may activate a main radio to receive the downlink traffic. In some examples, a network node may use a multi-tone LP-WUS and/or a multi-tone LP-SS. A multi-tone LP-WUS and/or a multi-tone LP-SS may be associated with multiple tones, with each tone referring to a subcarrier (SC) and/or a resource element (RE) allocated to a UE. The UE may monitor the set of tones to detect the presence of an LP-WUS and/or an LP-SS. Using a multi-tone low-power signal (rather than a single-tone low-power signal) may result in low-power signaling that is more robust to fading, thereby reducing communication errors between a network node and a UE in a deep sleep mode or a similar reduced power mode.

One or more tones of a multi-tone LP-WUS and/or a multi-tone LP-SS may overlap with frequency resources associated with downlink communications transmitted to other UEs in a wireless communication system, such as a physical downlink shared channel (PDSCH) communication or a similar communication being transmitted to UEs not in a deep sleep mode. In that regard, the other UEs may need to be configured with a rate matching pattern in order to avoid the tones associated with the multi-tone LP-WUS and/or the multi-tone LP-SS. Rate matching may refer to a network node indicating to a UE that certain resources are not available for a downlink communication (e.g., a PDSCH communication) because the resources are being used for another radio and/or signal (e.g., a multi-tone LP-WUS and/or a multi-tone LP-SS). In some examples, a UE may be configured with rate matching patterns having resource block (RB) and symbol level granularity or RE level granularity, indicating unavailable resources for a downlink communication. Accordingly, based at least in part on the rate matching pattern, a UE may decode a certain set of bits from a transport block (TB) associated with a downlink communication while avoiding certain other bits (e.g., bits associated with a LP-WUS, a LP-SS, or a similar transmission). Put another way, when multiple signals (e.g., a signal associated with a downlink communication and a signal associated with an LP-WUS and/or an LP-SS) arriving at a UE overlap, a network node may indicate, to a UE, a rate matching pattern that indicates which resources to avoid because the resources will not be included in the downlink communication (e.g., the resources will be used for other purposes, such as an LP-WUS, an LP-SS, or the like). In that regard, upon receiving the PDSCH or similar communication, the UE may avoid decoding certain bits according to the rate matching pattern, thereby decoding bits relevant to one signal (e.g., a downlink communication) and ignoring bits associated with another signal, not intended for the UE (e.g., an LP-WUS and/or an LP-SS intended for another UE).

However, existing rate matching patterns may be inadequate to accommodate the structure of multi-tone LP-WUSs and/or multi-tone LP-SSs. This may be because the multiple tones associated with the multi-tone LP-WUSs and/or the multi-tone LP-SSs may not align with existing rate matching patterns and/or configurations. Moreover, a subcarrier spacing (SCS) associated with the multi-tone LP-WUSs and/or the multi-tone LP-SSs may be different than an SCS of a bandwidth part (BWP) used for normal traffic (e.g., a BWP used to transmit a PDSCH to one or more other UEs). This may result in a network node needing to over rate-match to accommodate a multi-tone LP-WUS and/or a multi-tone LP-SS (e.g., excluding an entire bandwidth (BW) of the multi-tone LP-WUS and/or the multi-tone LP-SS from a PDSCH), which results in underutilization of resources because a multi-tone LP-WUS and/or a multi-tone LP-SS only occupies a small percentage of tones within its BW. Otherwise, a network node may be required to refrain from using multi-tone low-power signals, leading to use of LP-WUSs and/or LP-SSs that are more prone to fading and thus communication errors.

Some techniques and apparatuses described herein enable the use of multi-tone low-power signals, such as multi-tone LP-WUSs and/or multi-tone LP-SSs, by configuring one or more UEs in a wireless network with rate matching patterns associated with a multi-tone LP-WUS and/or a multi-tone LP-SS. For example, in aspects in which an SCS associated with a multi-tone LP-WUS and/or a multi-tone LP-SS is a same SCS as an SCS associated with normal traffic (e.g., an SCS associated with a PDSCH), the network node may configure the UE with a rate matching pattern that is defined similar to the multi-tone LP-WUS and/or the multi-tone LP-SS and/or the network node may configure the UE with a rate matching pattern by indicating an index of a selected rate matching pattern from a table of allowed rate matching patterns. Moreover, in aspects in which an SCS associated with the multi-tone LP-WUS and/or the multi-tone LP-SS is a different SCS than an SCS associated with normal traffic (e.g., an SCS associated with a PDSCH), the network node may configure the UE with an RB level rate matching pattern, a multi-RE level rate matching pattern, or an RE level rate matching pattern. Accordingly, the UE may successfully decode a downlink communication (e.g., a PDSCH) based at least in part on the rate matching pattern associated with the one of the multi-tone LP-WUS or the multi-tone LP-SS. As a result, multi-tone signals, such as multi-tone LP-WUSs and/or multi-tone LP-SSs, may be utilized in a wireless network, resulting in more robust low-power signaling and thus reduced communication errors between a network node and a UE in a deep sleep state, while enabling appropriate PDSCH decoding at other UEs in the network, resulting in increased utilization of network resources and thus improved spectral efficiency.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

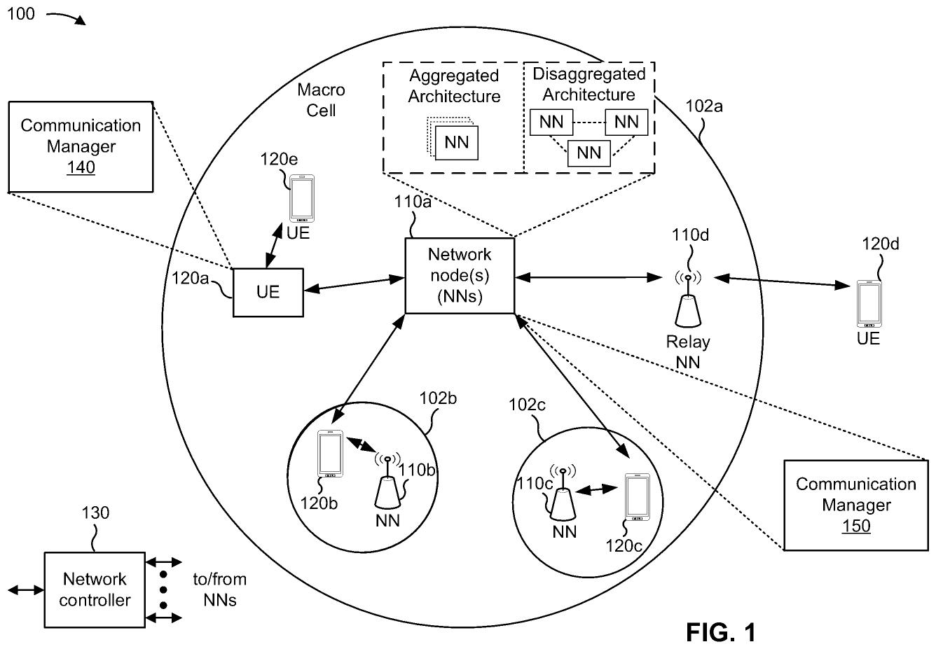

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 megahertz (MHz)-7.125 gigahertz (GHz)) and FR2 (24.25 GHz-52.6 GHZ). It should be understood that although a portion of FR 1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information indicating a rate matching pattern associated with one of a multi-tone LP-WUS or a multi-tone LP-SS; and decode a downlink communication based at least in part on the rate matching pattern associated with the one of the multi-tone LP-WUS or the multi-tone LP-SS. Additionally, or alternatively, the communication manager 140 may perform one or more other operations described herein.

In some aspects, the network node 110 may include a communication manager 150. As described in more detail elsewhere herein, the communication manager 150 may transmit, to a UE, configuration information indicating a rate matching pattern associated with one of a multi-tone LP-WUS or a multi-tone LP-SS; and transmit, to the UE, a downlink communication based at least in part on the rate matching pattern associated with the one of the multi-tone LP-WUS or the multi-tone LP-SS.

Additionally, or alternatively, the communication manager 150 may perform one or more other operations described herein.

As indicated above, FIG. 1 is provided as an example. Other examples may differ from what is described with regard to FIG. 1.

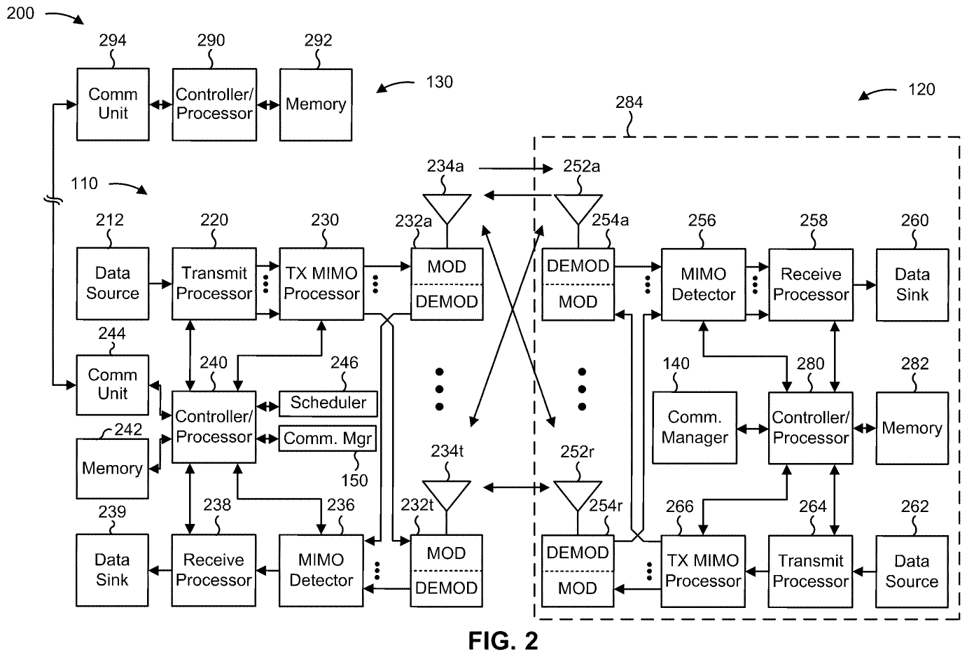

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

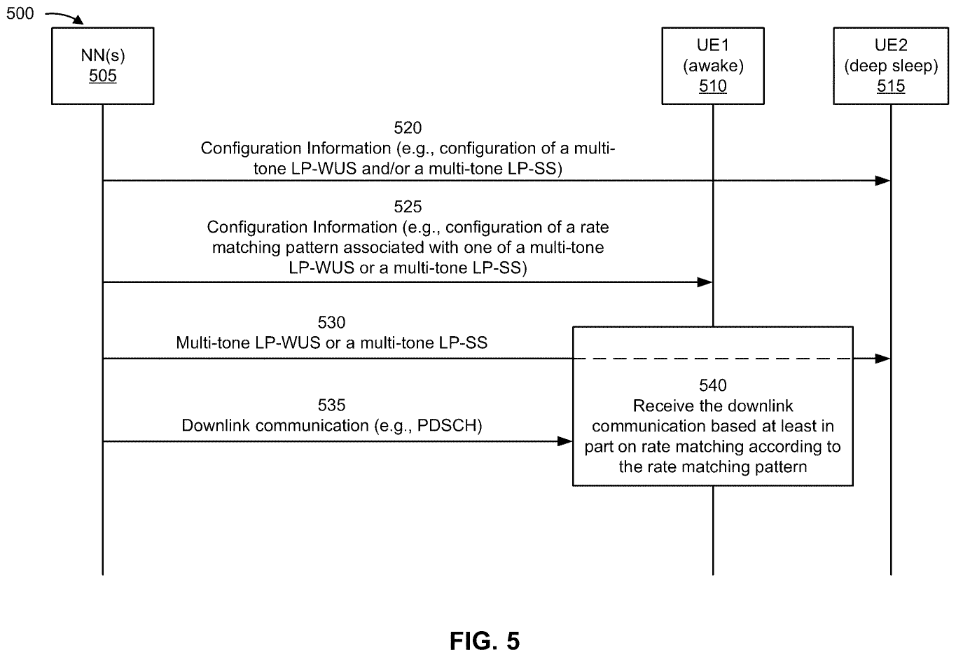

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

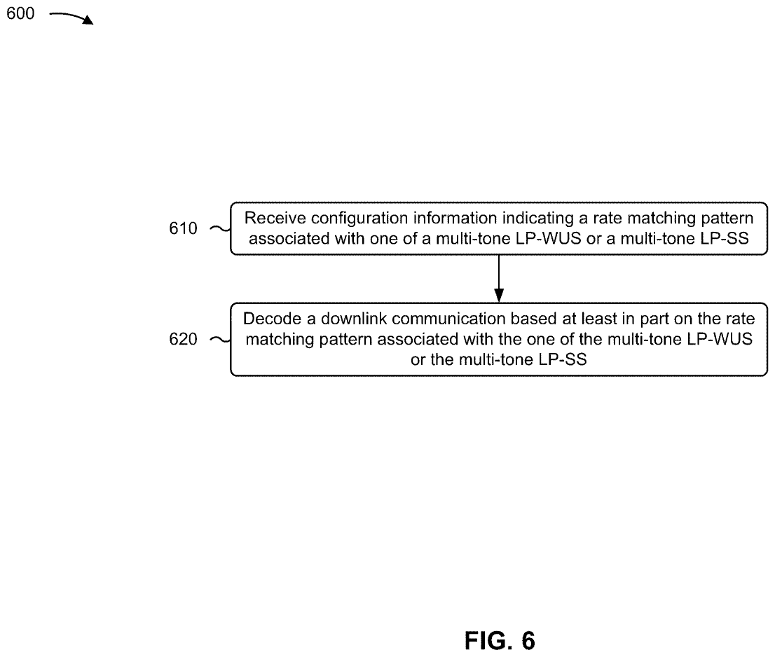

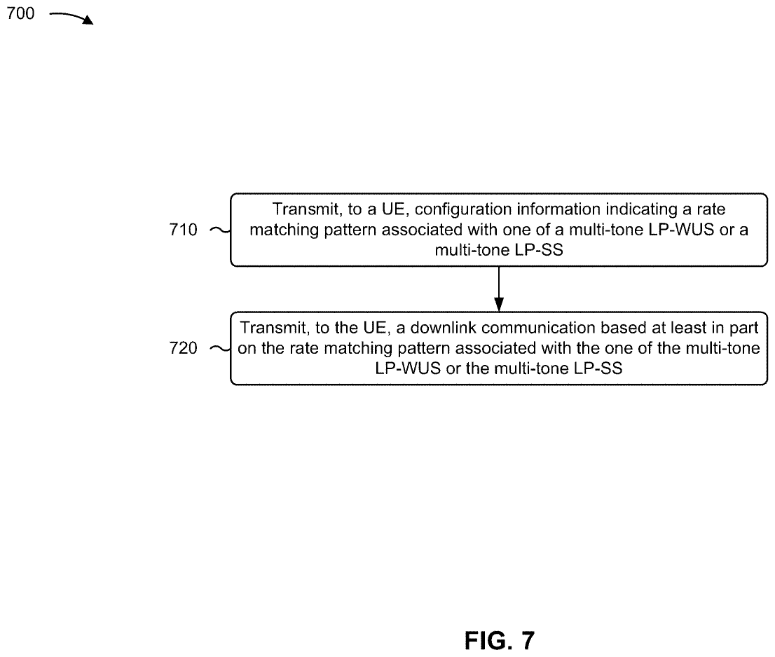

The controller/processor 240 of the network node 110, the controller/processor 280 of the UE 120, and/or any other component(s) of FIG. 2 may perform one or more techniques associated with rate matching for multi-tone LP-WUSs and/or multi-tone LP-SSs, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, the UE 120 includes means for receiving configuration information indicating a rate matching pattern associated with one of a multi-tone LP-WUS or a multi-tone LP-SS; and/or means for decoding a downlink communication based at least in part on the rate matching pattern associated with the one of the multi-tone LP-WUS or the multi-tone LP-SS. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE, configuration information indicating a rate matching pattern associated with one of a multi-tone LP-WUS or a multi-tone LP-SS; and/or means for transmitting, to the UE, a downlink communication based at least in part on the rate matching pattern associated with the one of the multi-tone LP-WUS or the multi-tone LP-SS. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

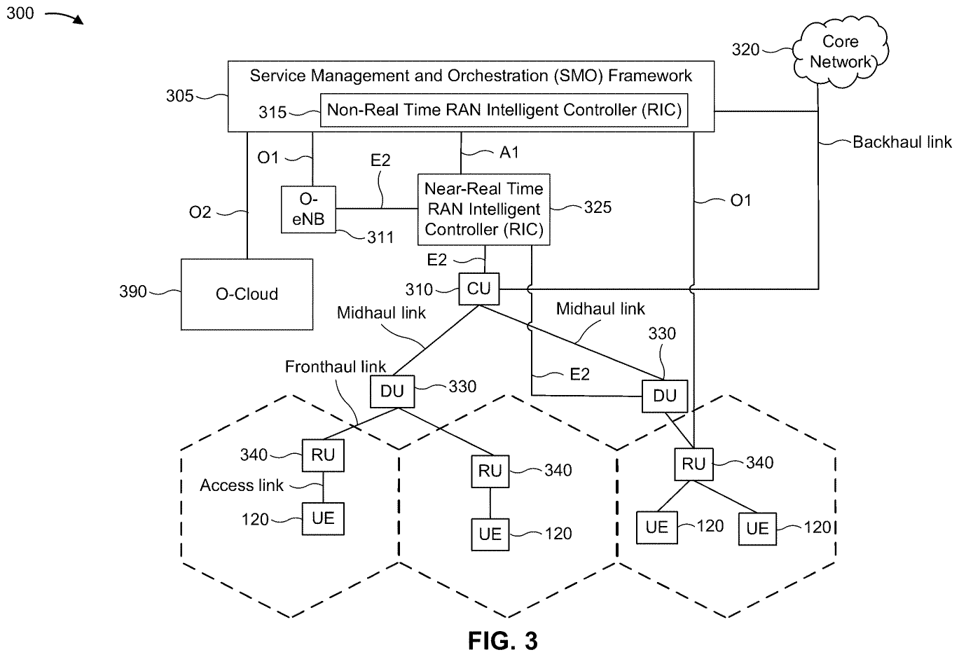

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as A1 interface policies).

As indicated above, FIG. 3 is provided as an example. Other examples may differ from what is described with regard to FIG. 3.

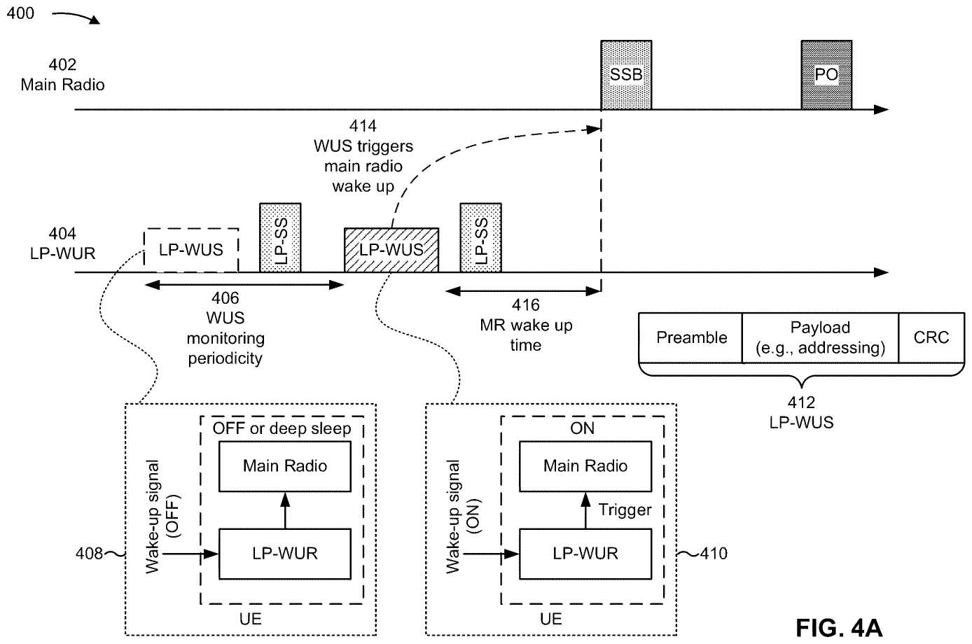

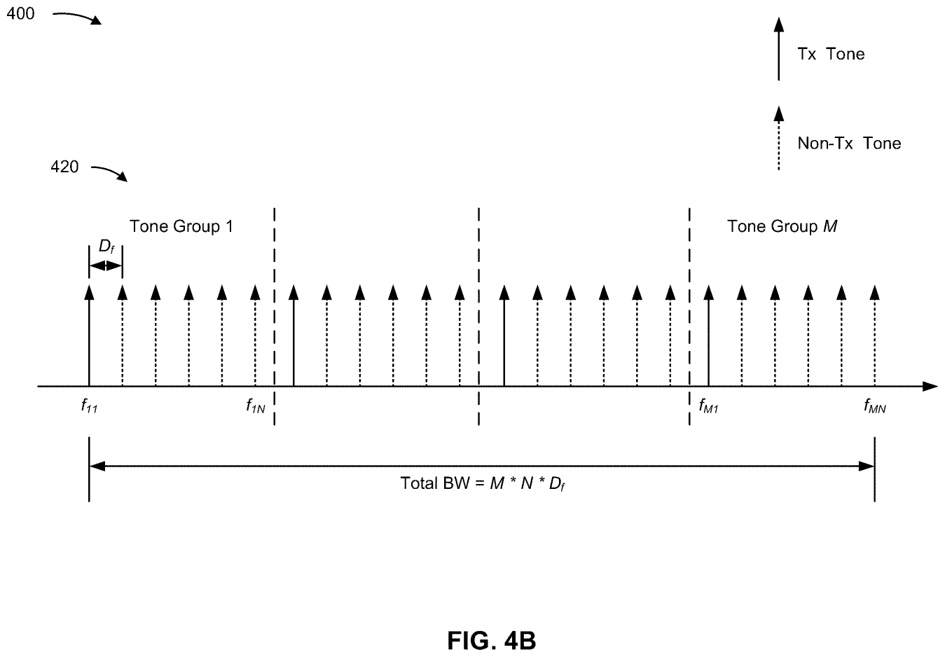

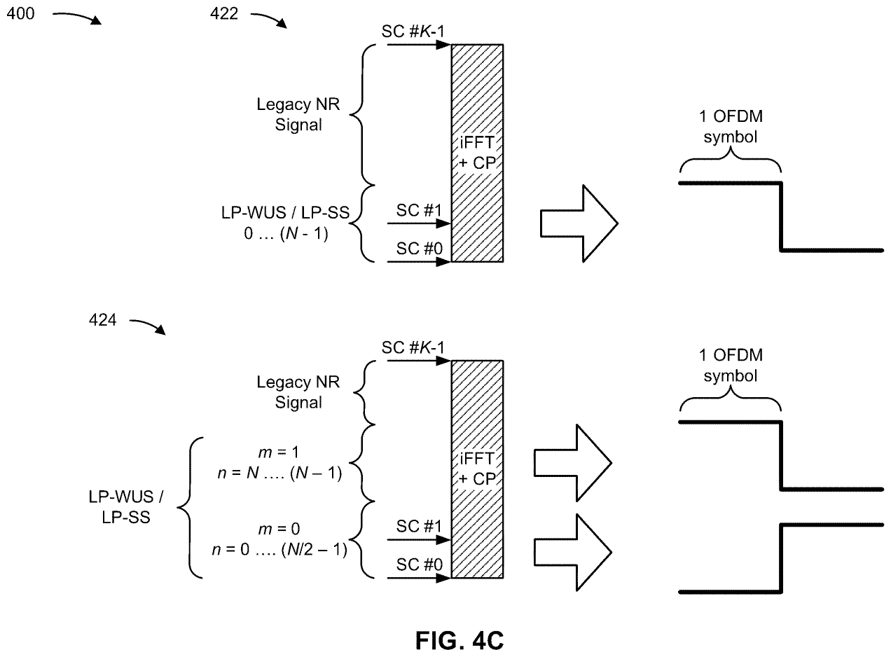

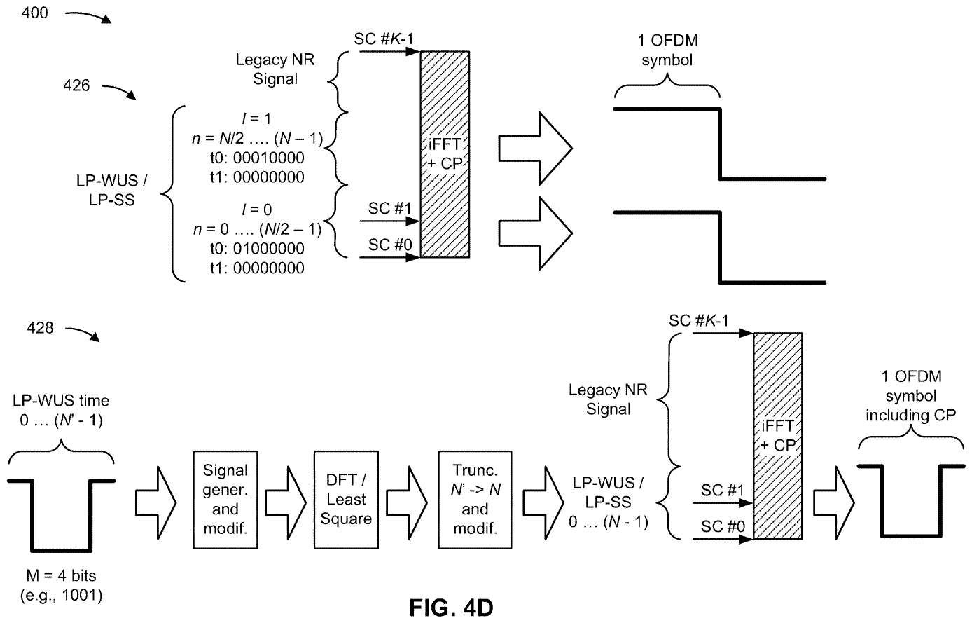

FIGS. 4A-4B are diagrams illustrating an example 400 associated with LP-WUSs and/or LP-SSs, in accordance with the present disclosure.

As shown in FIG. 4A, in some examples, a UE 120 may include multiple radios and/or receivers, such as a main radio (indicated by reference number 402) and an LP-WUR (indicated by reference number 404), among other radios and/or receivers. A main radio may be a receiver associated with normal wireless traffic and/or may be associated with relatively high energy consumption, while an LP-WUR may be a receiver associated with a relatively simple radio circuit designed to have a very low energy consumption. In some examples, the UE 120 may be configured to detect, receive, and/or measure different types of signals and/or communications using each radio and/or receiver. For example, the UE 120 may be configured to receive normal wireless communication traffic (e.g., synchronization signal blocks (SSBs), control signaling, data communications, and/or similar traffic) using the main radio, and the UE 120 may be configured to receive low-power signals (e.g., LP-WUSs, LP-SSs, and/or similar low-power signals) using the LP-WUR. In some examples, the UE 120 may be capable of powering off one or more radios and/or receivers when not in use, such as for a purpose of reducing power consumption at the UE 120. For example, when the UE 120 does not have data to transmit to a network node 110 and the network node 110 does not have data to transmit to the UE 120, the UE 120 may turn a main radio off, or else have the main radio enter a sleep state, in order to conserve power at the UE 120.

In some examples, as shown by reference number 406, the UE 120 may be configured with a wakeup signal (WUS) monitoring period, during which the LP-WUR may monitor for an LP-WUS, an LP-SS, or a similar low-power signal. As shown by reference number 408, if the UE 120 (and, more particularly, the LP-WUR of the UE 120) does not detect an LP-WUS, the UE 120 may maintain the main radio in an OFF mode, a deep sleep state, an ultra-low-power state (ULPS), or a similar low-power state. In some cases, when the main radio remains in the OFF mode, the UE 120 may synchronize timing with the network node 110 based on an LP-SS. More particularly, the UE 120 may receive the LP-SS using the LP-WUR and synchronize timing with the network node 110 based at least in part on the LP-SS, among other tasks.

As shown by reference number 410, if the UE 120 (and, more particularly, the LP-WUR of the UE 120) detects an LP-WUS during a WUS monitoring period, the LP-WUR may trigger the main radio to wake up and/or enter an ON mode to receive a communication from the network node 110. Put another way, the network node 110 may transmit an LP-WUS to the UE 120 on demand to indicate to the UE 120 that the network node 110 has signaling and/or data to transmit to the UE 120. As shown by reference number 412, in some examples, the LP-WUS may be associated with a relatively simple structure that includes a preamble, a payload (e.g., addressing information), and/or a cyclic redundancy check (CRC). When the UE 120 detects the LP-WUS, the UE 120 triggers a main radio wake up procedure (as shown by reference number 414). In some examples, the main radio may be associated with a period of time that is required to fully wake up the main radio and/or for the main radio to enter an ON mode, as shown by reference number 416. During the main radio wake up time, the UE 120 may continue to receive signals and/or communications via the LP-WUR, such as an LP-SS or similar communication. Once the main radio is fully operational, the UE 120 may thereafter perform operations using the main radio, such as measuring an SSB for a purpose of synchronizing timing with the network.

In some examples, an LP-WUS may be used to reduce unnecessary UE paging receptions for an idle or inactive UE 120, which may otherwise be resource-intensive for the UE 120. In such cases, the network node 110 may transmit the LP-WUS only when there is paging for an idle or inactive mode UE 120. If the LP-WUS is detected, as shown in FIG. 4A, the UE 120 may turn on the main radio and/or wake up the main radio, monitor an SSB using the main radio prior to a paging occasion (PO) for synchronization with the network, and/or receive a paging communication in the PO using the main radio. If the LP-WUS is not detected (meaning, in this example, that there is no paging intended for the idle or inactive UE 120), the UE 120 may maintain the main radio in a ULPS or similar low-power mode in order to conserve power resources at the UE 120.

In some examples, the LP-WUS and/or the LP-SS may be associated with a multi-tone signal (e.g., the LP-WUS may be a multi-tone LP-WUS and/or the LP-SS may be a multi-tone LP-SS). For example, FIG. 4B shows one example 420 of a multi-tone signal, such as a multi-tone LP-WUS and/or a multi-tone LP-SS. A multi-tone signal may be associated with a network allocating a set of tones (with each tone referring to an SC and/or an RE) to a UE or a UE group, such that the set of tones may be monitored by the corresponding UE or UE group to detect the presence of an LP-WUS and/or an LP-SS. In some examples, such as the example 420 shown in FIG. 4B, the set of tones allocated by the network to the LP-WUS and/or the LP-SS may be divided into M groups (shown as Tone Group 1 through Tone Group M in FIG. 4B) of N tones each (shown as tones ƒ₁₁ through ƒ_{1N} for Tone Group 1 and tones ƒ_{M1} through ƒ_{MN} for Tone Group M).

In such examples, each UE or group of UEs may be allocated one tone in each group of tones for purposes of an LP-WUS and/or an LP-SS (e.g., a total of M tones may be allocated to each UE or group of UEs). In such examples, using multiple tones per UE, instead of a single tone, may result in the LP-WUS and/or the LP-SS being more robust to fading. In some examples, the tones may not be equally spaced from each other, while, in some other examples the tones may be equally spaced from each other (as shown in FIG. 4B). For example, each tone may be spaced from a neighboring tone by a distance of D₇₁ Hz. In such cases, a total BW associated with the multi-tone LP-WUS and/or the multi-tone LP-SS may be equal to the product of the number of groups of tones, M, the number of tones in each group, N, and the spacing between neighboring tones, D_{ƒ} (e.g., Total BW=M×N x D_{ƒ}).

FIGS. 4C and 4D show example waveforms that may be associated with multi-tone LP-WUSs and/or multi-tone LP-SSs. In some examples, a multi-tone LP-WUS and/or a multi-tone LP-SS may be associated with a multi-carrier amplitude shift keying (MC-ASK) modulation that includes K SCs and/or REs associated with the iFFT of a CP-OFDM, with N SCs and/or REs (e.g., N tones) of the K SCs and/or REs associated with the multi-tone LP-WUS and/or the multi-tone LP-SS. Moreover, as shown in FIG. 4C by reference number 422, in some examples the multi-tone LP-WUS and/or the multi-tone LP-SS may be associated with on-off (OOK) modulation in a single-bit in one OFDM symbol, sometimes referred to as OOK-1. In such examples, for OOK=1, all SCs of the multi-tone LP-WUS and/or the multi-tone LP-SS may be modulated, and, for OOK=0, all SCs of the multi-tone LP-WUS and/or the multi-tone LP-SS may be zero power (from a base-band point of view).

In some other examples, as shown in FIG. 4C by reference number 424, the multi-tone LP-WUS and/or the multi-tone LP-SS may be associated with parallel M-bit OOK modulation in the frequency domain, sometimes referred to as OOK-2. In such examples, the N SCs of the multi-tone LP-WUS and/or the multi-tone LP-SS may be separated into m segments (with m=2 in FIG. 4C), and, in some examples, with guard bands in between the m segments and/or around the frequency comprising the multi-tone LP-WUS and/or the multi-tone LP-SS. In such examples, for OOK=1, all SCs of a corresponding segment of the multi-tone LP-WUS and/or the multi-tone LP-SS may be modulated, and, for OOK=0, all SCs of the corresponding segment of the multi-tone LP-WUS and/or the multi-tone LP-SS may be zero power (from a base-band point of view).

In some other examples, as shown in FIG. 4D by reference number 426, the multi-tone LP-WUS and/or the multi-tone LP-SS may be associated with multi-tone single-bit OOK modulation, sometimes referred to as OOK-3. In such examples, the N SCs of the multi-tone LP-WUS and/or the multi-tone LP-SS may be separated into l segments (with l=2 in FIG. 4D), without guard bands in between the/segments (but, in some cases, with guard bands around the frequency comprising the multi-tone LP-WUS and/or the multi-tone LP-SS). In such examples, for OOK=1, one SC (which may be known to a UE) of each segment of the multi-tone LP-WUS and/or the multi-tone LP-SS may be modulated, and the rest of the SCs of the segment may be zero power (from a base-band point of view). For OOK=0, all SCs in all segments of the multi-tone LP-WUS and/or the multi-tone LP-SS may be zero power (from a base-band point of view).

In some other examples, as shown in FIG. 4D by reference number 428, the multi-tone LP-WUS and/or the multi-tone LP-SS may be associated with a transform M-bit OOK modulation in the time domain, sometimes referred to as OOK-4. In such examples, for OOK=1, N SCs of OOK-1 may be generated by a transformation operation, such as by using a DFT and/or a least squares transform. More particularly, N′ samples may be generated from M bits, and signal modification may or may not be used. The N′ samples may undergo a transformation (e.g., one of a DFT or a least squares transform), and truncation and/or other modifications may or may not be used to arrive at N samples (in that regard, if truncation and/or other modifications are not used, N′ may be equal to N). In some examples, N′ may be the same as K.

In some examples, the modulated SCs associated with OOK-1, OOK-2, OOK-3, OOK-4, and/or another waveform associated with the multi-tone LP-WUS and/or the multi-tone LP-SS may be quadrature amplitude modulation (QAM) symbols, sequences, or other types of signals. Moreover, in some aspects, OOK-1, OOK-2, OOK-3, OOK-4, and/or another waveform associated with the multi-tone LP-WUS and/or the multi-tone LP-SS may be associated with one or more guard-band SCs that are zero power (from the base-band point of view). In some examples, in addition to the one or more segments associated with OOK-1, OOK-2, OOK-3, OOK-4, and/or another waveform associated with the multi-tone LP-WUS and/or the multi-tone LP-SS, two additional segments (e.g., one always modulated and one always zero power, from the base-band point of view) may be transmitted as part of the multi-tone LP-WUS and/or the multi-tone LP-SS. Moreover, in some examples, additional OOK techniques may be used in connection with the multi-tone LP-WUS and/or the multi-tone LP-SS, such as OOK-1 with multiple bits in one OFDM symbol, or a similar scheme.

In some other examples, a multi-tone LP-WUS and/or a multi-tone LP-SS may be associated with a multi-carrier frequency shift keying (MC-FSK) modulation. In one example (sometimes referred to as FSK-1), the N SCs of the multi-tone LP-WUS and/or the multi-tone LP-SS may be separated into M pairs of segments (with M>0 and N>1), with potential guard bands in between the M segments and/or around the BW comprising the multi-tone LP-WUS and/or the multi-tone LP-SS. In such examples, each segment may comprise one SC or multiple contiguous SCs. Moreover, in a pair of segments, of the M pairs of segments, a first segment may be modulated, and a second segment may be zero power (from the base-band point of view).

In a second example (sometimes referred to as FSK-2), the N SCs of the multi-tone LP-WUS and/or the multi-tone LP-SS may be separated into 2^{M} segments (with M>0 and N>1), with potential guard bands in between the 2^{M} segments and/or around the BW comprising the multi-tone LP-WUS and/or the multi-tone LP-SS. In such examples, each segment may comprise one SC or multiple contiguous SCs. Moreover, one segment, from the 2^{M} pairs of segments, may be modulated and the other segments may be zero power (from the base-band point of view).

When one or more of the above multi-tone LP-WUSs and/or the multi-tone LP-SSs are being used in a network, certain UEs 120 may be configured with a rate matching pattern in order to avoid decoding SCs associated with a multi-tone LP-WUS and/or a multi-tone LP-SS (e.g., certain UEs may be configured to avoid resources associated with the multi-tone LP-WUS and/or the multi-tone LP-SS when receiving a downlink communication). Put another, based at least in part on a rate matching pattern, a UE may decode a certain set of bits from a TB associated with a downlink communication (e.g., a PDSCH communication) while avoiding certain other bits (e.g., bits associated with an LP-WUS, an LP-SS, or a similar transmission). Put another way, when multiple signals arriving at a UE 120 overlap, such as a signal associated with a downlink communication and a signal associated with an LP-WUS and/or an LP-SS, a network node 110 may indicate, to the UE 120, a rate matching pattern that identifies which resources to avoid because the resources will not be included in the downlink communication (e.g., the resources will be used for other purposes, such as an LP-WUS or the like). In that regard, upon receiving the PDSCH or similar communication, the UE 120 may avoid decoding certain bits according to the rate matching pattern, thereby decoding bits relevant to one signal (e.g., a downlink communication) and ignoring bits associated with another signal, not intended for the UE 120 (e.g., an LP-WUS and/or an LP-SS intended for another UE).

However, traditional rate matching patterns may be inadequate for certain signals, such as multi-tone LP-WUSs and/or multi-tone LP-SSs. More particularly, traditional rate matching patterns may include RE level rate matching using zero power channel state information reference signals (ZP-CSI-RSs), RB and symbol level rate matching configured patterns, rate matching patterns associated with LTE CRSs, and the like. ZP-CSI-RS rate matching patterns may be RE level rate matching patterns used to rate-match around CSI-RS transmissions, and thus such rate matching patterns may be defined similar to non-zero-power CSI-RSs (NZP-CSI-RSs). RB and symbol level rate matching patterns may be semi-statically configured resource patterns that may be periodic or dynamically activated. Such RB and symbol level rate matching patterns may be defined with bitmaps on an RB-symbol grid and by using a periodicity and an offset. The rate matching patterns may be defined on a cell level or a BWP level. If a rate matching pattern is defined on a cell level, the rate matching patten may only be applicable to PDSCHs with the same SCS as the rate matching pattern. In some examples, multiple patterns may be configured for a BWP, and a final pattern may be a combination of the multiple patterns. Moreover, for dynamic activation, rate matching patterns may be organized into pattern groups (e.g., up to two groups), and downlink control information (DCI) may be used to activate the groups. If a rate matching pattern is not associated with a pattern group, then the rate matching pattern may be always active (e.g., the rate matching pattern may be a periodic pattern).

In that regard, existing rate matching patterns may be inadequate for certain signals, such as multi-tone LP-WUSs and/or multi-tone LP-SSs. This may be because the multiple tones associated with the multi-tone LP-WUSs and/or the multi-tone LP-SSs, such as the multiple tones described above in connection with FIGS. 4B-4D, may not align with one of the existing rate matching patterns described above. Moreover, an SCS associated with the multi-tone LP-WUSs and/or the multi-tone LP-SSs may be different than an SCS of a BWP used for normal NR traffic (e.g., a BWP used to transmit a PDSCH to one or more other UEs). Accordingly, existing rate matching patterns may be inadequate for multi-tone LP-WUSs and/or multi-tone LP-SSs, resulting in a network node over rate-matching for a multi-tone LP-WUS and/or a multi-tone LP-SS (e.g., by excluding an entire BW of the multi-tone LP-WUS and/or the multi-tone LP-SS from a PDSCH), which results in underutilization of resources because a multi-tone LP-WUS and/or a multi-tone LP-SS only occupies a small percentage of tones within its BW, or else the network node refraining from using multi-tone signals altogether, resulting in LP-WUSs and/or LP-SSs that are more prone to fading and thus more communication errors.

Some techniques and apparatuses described herein enable configuration of rate matching patterns associated with multi-tone low-power signals. In some aspects, a UE may be configured with a rate matching pattern associated with one of a multi-tone LP-WUS or a multi-tone LP-SS. For example, in aspects in which an SCS associated with the multi-tone LP-WUS and/or the multi-tone LP-SS is a same SCS as an SCS associated with normal traffic (e.g., an SCS associated with a PDSCH), a UE may be configured with a rate matching pattern that is defines similar to the multi-tone LP-WUS and/or the multi-tone LP-SS, and/or the UE may be configured with a rate matching pattern that is indicated using an index of a selected rate matching pattern from a table of allowed rate matching patterns. In aspects in which an SCS associated with the multi-tone LP-WUS and/or the multi-tone LP-SS is a different SCS than an SCS associated with normal traffic (e.g., an SCS associated with a PDSCH), the rate matching pattern may be configured as an RB level rate matching pattern, a multi-RE level rate matching pattern, or an RE level rate matching pattern that substantially tracks the multi-tone LP-WUS and/or the multi-tone LP-SS. Accordingly, the UE may decode a downlink communication (e.g., a PDSCH) based at least in part on the rate matching pattern associated with the one of the multi-tone LP-WUS or the multi-tone LP-SS. As a result, multi-tone signals, such as multi-tone LP-WUSs and/or multi-tone LP-SSs, may be utilized in a wireless network, resulting in more robust signaling and thus reduced communication errors between a network node and a UE in a deep sleep state, while enabling improved rate matching at other UEs in the network, resulting in increased utilization of network resources and thus improved spectral efficiency.

As indicated above, FIGS. 4A-4D are provided as examples. Other examples may differ from what is described with respect to FIGS. 4A-4D.

FIG. 5 is a diagram of an example 500 associated with rate matching for multi-tone LP-WUSs and/or LP-SSs, in accordance with the present disclosure. As shown in FIG. 5, a network node 505 (e.g., network node 110, a CU, a DU, and/or an RU) may communicate with one or more UEs (e.g., UE 120), shown as UE1 510 and UE2 515 in FIG. 5. In some aspects, the network node 505, UE1 510, and UE2 515 may be part of a wireless network (e.g., wireless network 100). The network node 505, UE1 510, and UE2 515 may have established a wireless connection prior to operations shown in FIG. 5. In some aspects, the UE1 510 and/or the UE2 515 may be associated with multiple radios and/or receivers, such as a main radio and an LP-WUR, as described above in connection with FIG. 4A. In that regard, the UE1 510 and/or the UE2 515 may be capable of communicating with the network node 505 while in a normal, or “awake” mode, using the main radio, and/or the UE1 510 and/or the UE2 515 may be capable of communicating with the network node 505 while in a “deep sleep” mode or similar low-power mode using the LP-WUR. For example, in the aspects shown in FIG. 5, the UE1 510 may be in a normal and/or awake mode and configured to receive normal NR traffic, and/or the UE2 515 may be in a reduced-power and/or deep-sleep mode and configured to monitor for an LP-WUS and/or an LP-SS using an LP-WUR.

As shown by reference numbers 520 and 525, the network node 505 may transmit, and the UE1 510 and the UE2 515 may receive, configuration information. In some aspects, the UE1 510 and the UE2 515 may receive the configuration information via one or more of RRC signaling, one or more MAC control elements (MAC-CEs), and/or DCI, among other examples. In some aspects, the configuration information may include an indication of one or more configuration parameters (e.g., already known to the UE1 510 and the UE2 515 and/or previously indicated by the network node 505 or other network device) for selection by the UE1 510 and the UE2 515, and/or explicit configuration information for the UE1 510 and the UE2 515 to use to configure the UE1 510 and the UE2 515, among other examples.

In some aspects, as shown by reference number 520, the network node 505 may transmit, and the UE2 515 may receive, configuration information indicating a configuration of a multi-tone LP-WUS and/or a multi-tone LP-SS. For example, the configuration information may indicate a configuration of one of the multi-tone LP-WUSs and/or the multi-tone LP-SSs described above in connection with FIGS. 4A-4D. In that regard, the UE2 515 may be configured to periodically monitor, while in a deep-sleep mode or a similar state, certain resources (e.g., tones) for a multi-tone LP-WUS and/or a multi-tone LP-SS using an LP-WUR, which is described in more detail below in connection with reference number 530.

As described above in connection with FIGS. 4A-4D, the multi-tone LP-WUS and/or the multi-tone LP-SS may overlap with frequency resources used by the network node 505 to transmit a downlink communication (e.g., a PDSCH communication) to the UE1 510. Accordingly, in some aspects, the configuration information may indicate, to the UE1 510, a rate matching pattern associated with a downlink communication indicating which frequency resources to avoid when decoding the downlink communication. More particularly, the network node 505 may indicate certain resources to avoid when decoding the downlink communication because the resources may be associated with the multi-tone LP-WUS and/or the multi-tone LP-SS (e.g., the resources may be used to transmit the multi-tone LP-WUS and/or the multi-tone LP-SS to another UE) and not the downlink communication. In that regard, and as shown by reference number 525, in some aspects the network node 505 may transmit, and the UE1 510 may receive, configuration information indicating a rate matching pattern associated with the multi-tone LP-WUS and/or the multi-tone LP-SS.

In some aspects, an SCS associated with the one of the multi-tone LP-WUS or the multi-tone LP-SS may be a same SCS as an SCS associated with a BWP used to communicate normal traffic to the UE1 510 (e.g., the BWP used by the UE1 510 to receive the downlink communication), while, in some other aspects, the SCS associated with the one of the multi-tone LP-WUS or the multi-tone LP-SS is a different SCS than the SCS associated with the BWP used to receive the downlink communication. For example, in some aspects, the SCS associated with the multi-tone LP-WUS or the multi-tone LP-SS may be larger than the SCS associated with BWP.

In aspects in which the SCS associated with the multi-tone LP-WUS and/or the multi-tone LP-SS is a same SCS as an SCS associated with the BWP used to receive the downlink communication, the rate matching pattern may be an RE level rate matching pattern that mimics the resource allocation of the multi-tone LP-WUS or the multi-tone LP-SS. In such aspects, the RB location of the rate matching pattern may be configured with a starting frequency location associated with the rate matching pattern and an ending frequency location associated with the rate matching pattern and/or with a bitmap indicating the frequency resources (e.g., RBs) associated with the rate matching pattern. In such aspects, the UE1 may avoid certain REs, as indicated by the rate matching pattern, within a frequency range (e.g., RBs) indicated by the starting frequency location associated and the ending frequency location and/or within a frequency range indicated by the bitmap.

Additionally, or alternatively, the RE level rate matching pattern may be defined similar to the multi-tone LP-WUS and/or the multi-tone LP-SS, such as one of the multi-tone LP-WUSs and/or the multi-tone LP-SSs described above in connection with FIGS. 4A-4D. For example, the rate matching pattern may be defined according to multiple groups of tones, with one or more tones from each group of tones included in the rate matching pattern. Put another way, in some aspects, the rate matching pattern may be associated with multiple rate matching REs, with the multiple rate matching REs including one or more REs from each of multiple RE groups associated with the rate matching pattern.

In some aspects, a location of the tones (e.g., SCs) associated with the multi-tone LP-WUS and/or the multi-tone LP-SS, and thus associated with the rate matching pattern, may be specified and/or configured according to a formula associated with an identifier (ID) related to the one of the multi-tone LP-WUS or the multi-tone LP-SS. For example, a wireless communication standard promulgated by the 3GPP or similar standard may specify a formula that randomizes a location of tones associated with the multi-tone LP-WUS and/or the multi-tone LP-SS (and thus a location of tones associated with the rate matching pattern) based on an ID. In some aspects, the formula may be associated with a hash function in which the ID determines a location of tones within a tone group.

In some other aspects, the configuration information may indicate the rate matching pattern by using a bitmap indicating frequency locations of the multiple rate matching REs. In some aspects, using a bitmap to indicate a location of the multiple rate matching REs (e.g., tones) may require more signaling overhead than randomizing a location of the tones based at least in part on a formula or the like, but may provide more flexibility associated with the rate matching pattern, such as by allowing for reuse of a rate matching pattern for future signaling.

In some aspects, multiple rate matching patterns may be defined (e.g., specified) as a table, such as a table associated with a zero power WUS (ZP-WUS) or a similar table. In such aspects, the table may include a pre-defined set of allowed rate matching patterns, similar to how a ZP-CSI-RS table is defined. In such aspects, the configuration information may indicate which rate matching pattern, of the pre-defined set of allowed rate matching patterns, will be used for the downlink communication. Put another way, in some aspects, the configuration information may indicate the rate matching pattern by indicating an index associated with a lookup table of multiple allowed rate matching patterns.

In aspects in which the SCS associated with the multi-tone LP-WUS and/or the multi-tone LP-SS is a different SCS than the SCS associated with the BWP used to receive the downlink communication, a size of an SCS associated with the multi-tone LP-WUS and/or the multi-tone LP-SS may be equal to a multiple of an RB size of the BWP used to receive the downlink communication. Put another way, an SCS associated with the multi-tone LP-WUS and/or the multi-tone LP-SS may be a multiple of an RB size associated with a target frequency band in which the multi-tone LP-WUS, the multi-tone LP-SS, and/or the downlink communication is to be transmitted. For example, the SCS associated with the multi-tone LP-WUS and/or the multi-tone LP-SS may be a product of an integer (e.g., 12, corresponding a number of SCs associated with an RB, or some multiple thereof, such as 24, 36, 42, and so forth) and a maximum permissible SCS size associated with a frequency range encompassing the BWP. For example, in aspects in which FR1 is associated with 15 kHz SCS, 30 kHz SCS, and/or 60 kHz SCS, a maximum SCS associated with FR1 is 60 kHz, resulting in a maximum permissible RB size of 720 kHz (e.g., 12×60 kHz=720 kHz). In such aspects, when the BWP is encompassed by FR1, an SCS associated with the multi-tone LP-WUS may be a multiple of the maximum permissible RB size of the BWP (e.g., 720 kHz), such as one of 720 kHz×1=720 kHz, 720 kHz×2=1440 kHz, 720 kHz×3=2160 kHz, 720 kHz×4=2880 kHz, or so forth.

In such aspects, the rate matching pattern may be configured as an RB level rate matching pattern in which the rate matching RBs correspond to tones spaced by an integer multiplied the maximum SCS of the corresponding frequency range (e.g., in the example described above, the rate matching pattern may be associated with an RB level rater matching pattern in which rate matching RBs correspond to 720 kHz tones in the multi-tone LP-WUS and/or the multi-tone LP-SS, or a multiple thereof such as one of 1440 kHz tones, 2160 kHz tones, 2880 kHz tones, or the like). Put another way, in some aspects, the rate matching pattern may be associated with groups of one or more rate matching RBs, with each group of the one or more rate matching RBs corresponding to a tone of the one of the multi-tone LP-WUS or the multi-tone LP-SS.

In some aspects, the RB level rate matching pattern may be associated with a table of pre-defined allowed RB level rate matching patterns, with the configuration information indicating an index to indicate one of the allowed RB level rate matching patterns. Put another way, the configuration information may indicate the rate matching pattern by indicating an index associated with a lookup table of multiple allowed rate matching patterns. In some other aspects, the RB level rate matching pattern may be indicated by a bitmap indicating the location of the rate matching RBs, which may require more signaling overhead than the lookup table but which may permit reusing rate matching patterns for future signaling. In such aspects, a granularity of the bitmap may be associated with the SCS of the BWP. For example, one RB in 720 kHz (e.g., the SCS of the multi-tone LP-WUS and/or the multi-tone LP-SS in the above-described example) corresponds to 24 RBs in 30 kHz SCS. Thus, each rate matching RB associated with the multi-tone LP-WUS and/or the multi-tone LP-SS may be indicated to the UE1 510 using 24 bits in a bitmap having a granularity associated with the SCS of the BWP (e.g., 30 kHz).

In some other aspects, the SCS associated with the multi-tone LP-WUS and/or the multi-tone LP-SS may not necessarily be a multiple an SCS associated with a target frequency band in which the multi-tone LP-WUS, the multi-tone LP-SS, and/or the downlink communication is to be transmitted. Put another way, an SCS of the multi-tone LP-WUS and/or the multi-tone LP-SS intended for one UE in a wireless communication system (e.g., UE2 515) may not necessarily be defined as a multiple of RBs from a view of other UEs in the system (e.g., UE1 510). Returning to the above-described example in which the BWP is associated with FR1, the SCS of the multi-tone LP-WUS and/or the multi-tone LP-SS may not be a multiple of 720 kHz.

In such aspects, the rate matching pattern may be a multi-RE rate matching pattern. For example, the rate matching pattern may be associated with multiple groups of rate matching REs, with each group of rate matching REs, of the multiple groups of rate matching REs, including a number of REs equal to a quotient of a total number of REs associated with the rate matching pattern and an integer (sometimes referred to as X). In such aspects, the configuration information may indicate the rate matching pattern by using a bitmap indicating frequency locations of the multiple groups of rate matching REs, with the bitmap length corresponding to the total number of REs associated with the rate matching pattern divided by X. Put another way, X may define the width of tones in each group of tones. For example, a 120 kHz SCS multi-tone LP-WUS and/or multi-tone LP-SS may be defined as four consecutive tones from a perspective of UEs associated with a BWP defined with 30 kHz SCS, and thus X may be equal to four in such examples. In some aspects, X may be fixed (e.g., defined according to a wireless communication standard, or the like), while, in some other aspects, X may be a configurable parameter (e.g., the configuration information may further indicate the integer, X).

In some other aspects, a rate matching pattern associated with a multi-tone LP-WUS and/or a multi-tone LP-SS that has an SCS that is not necessarily a multiple an SCS associated with a target frequency band may be an RE level rate matching pattern (e.g., the rate matching pattern may be associated with multiple rate matching REs). In such aspects, the configuration information may indicate the rate matching pattern by using a bitmap indicating frequency locations of the multiple rate matching REs. In such aspects, signaling of the rate matching pattern may be relatively simple as compared to the multi-RE rate matching pattern described above, because the bitmap may include a one-to-one correlation to REs to be avoided by the UE1 510. However, this option may increase signaling overhead, because the bitmap may be relatively long as compared to the multi-RE rate matching pattern described above (e.g., in aspects in which X=four, the bitmap may be four times as long).

In some aspects, the rate matching pattern may be an on-demand pattern (e.g., the rate matching pattern may be a dynamically indicated rate matching pattern). In such aspects, the rate matching pattern may be triggered by a DCI or similar communication. Moreover, the dynamic rate matching pattern may be defined similar to a ZP-CSI-RS as defined by a wireless communication standard (e.g., a standard promulgated by the 3GPP) and/or a rate matching pattern group as defined by a wireless communication standard. In some other aspects, the rate matching pattern may be a periodic rate matching pattern or a semi-persistent rate matching pattern. In such aspects, the rate matching pattern may be indicated by an RRC configuration of a BWP or similar configuration information. Moreover, in aspects in which the rate matching pattern is a semi-persistent rate matching pattern, the semi-persistent rate matching pattern may be activated using any suitable signaling, such as layer 1 signaling (e.g., using DCI), layer 2 signaling (e.g., using a MAC-CE), or similar signaling.

The UE1 510 and the UE2 515 may configure themselves based at least in part on the configuration information. In some aspects, the UE1 510 and the UE2 515 may be configured to perform one or more operations described herein based at least in part on the configuration information.

As shown by reference number 530, in some aspects the network node 505 may transmit, and the UE2 515 may receive, the multi-tone LP-WUS and/or the multi-tone LP-SS. Moreover, as shown by reference number 535, in some aspects the network node 505 may transmit, and the UE1 510 may receive, a downlink communication (e.g., a communication associated with a PDSCH). In some aspects, at least some resources associated with the multi-tone LP-WUS and/or the multi-tone LP-SS may overlap with at least some resources associated with the downlink communication (e.g., at least some resources associated with the PDSCH).

Accordingly, as shown by reference number 540, the UE1 510 may decode the downlink communication based at least in part on the rate matching pattern associated with the multi-tone LP-WUS and/or the multi-tone LP-SS. For example, the UE1 510 may avoid REs and/or RBs associated with the multi-tone LP-WUS and/or the multi-tone LP-SS when decoding the downlink communication, as indicated by one of the configured rate matching patterns described above in connection with reference number 525.

Based at least in part on the network node 505 configuring the UE1 510 with a rate matching pattern associated with the multi-tone LP-WUS and/or the multi-tone LP-SS, the network node 505, the UE1 510, and/or the UE2 515 may conserve computing, power, network, and/or communication resources that may have otherwise been consumed using traditional rate matching patterns and/or single-tone LP-WUSs and/or single-tone LP-SSs. For example, based at least in part on the network node 505 configuring the UE1 510 with a rate matching pattern associated with the multi-tone LP-WUS and/or the multi-tone LP-SS, the network node 505 and the UE1 510 may communicate with a reduced error rate and/or the network node 505, and the UE2 515 may communicate using multi-tone LP-WUSs and/or multi-tone LP-SSs that are more robust to fading as compared to single-tone LP-WUSs and/or single-tone LP-SSs, which may conserve computing, power, network, and/or communication resources that may have otherwise been consumed to detect and/or correct communication errors.

As indicated above, FIG. 5 is provided as an example. Other examples may differ from what is described with respect to FIG. 5.

FIG. 6 is a diagram illustrating an example process 600 performed, for example, by a UE, in accordance with the present disclosure. Example process 600 is an example where the UE (e.g., UE1 510) performs operations associated with rate matching for multi-tone LP-WUSs and/or multi-tone LP-SSs.

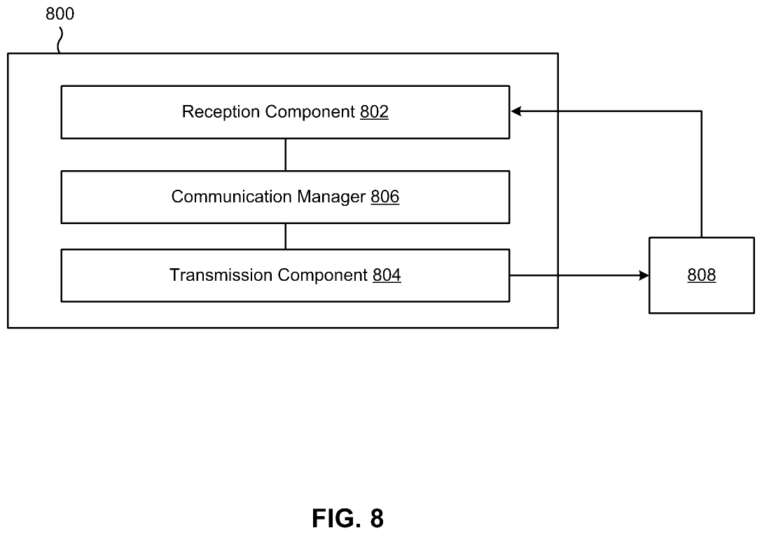

As shown in FIG. 6, in some aspects, process 600 may include receiving configuration information indicating a rate matching pattern associated with one of a multi-tone LP-WUS or a multi-tone LP-SS (block 610). For example, the UE (e.g., using reception component 802 and/or communication manager 806, depicted in FIG. 8) may receive configuration information indicating a rate matching pattern associated with one of a multi-tone LP-WUS or a multi-tone LP-SS, as described above.

As further shown in FIG. 6, in some aspects, process 600 may include decoding a downlink communication based at least in part on the rate matching pattern associated with the one of the multi-tone LP-WUS or the multi-tone LP-SS (block 620). For example, the UE (e.g., using reception component 802 and/or communication manager 806, depicted in FIG. 8) may decode a downlink communication based at least in part on the rate matching pattern associated with the one of the multi-tone LP-WUS or the multi-tone LP-SS, as described above.

Process 600 may include additional aspects, such as any single aspect or any combination of aspects described below and/or in connection with one or more other processes described elsewhere herein.

In a first aspect, an SCS associated with the one of the multi-tone LP-WUS or the multi-tone LP-SS is a same SCS as an SCS associated with a bandwidth part used to receive the downlink communication.

In a second aspect, alone or in combination with the first aspect, the configuration information indicates a starting frequency location associated with the rate matching pattern and an ending frequency location associated with the rate matching pattern.

In a third aspect, alone or in combination with one or more of the first and second aspects, the configuration information includes a bitmap indicating frequency resources associated with the rate matching pattern.

In a fourth aspect, alone or in combination with one or more of the first through third aspects, the rate matching pattern is associated with multiple rate matching REs, and the multiple rate matching REs include one or more REs from each of multiple RE groups associated with the rate matching pattern.

In a fifth aspect, alone or in combination with one or more of the first through fourth aspects, the configuration information indicates the rate matching pattern by indicating frequency locations of the multiple rate matching REs based at least in part on a formula associated with an identifier related to the one of the multi-tone LP-WUS or the multi-tone LP-SS.

In a sixth aspect, alone or in combination with one or more of the first through fifth aspects, the configuration information indicates the rate matching pattern by using a bitmap indicating frequency locations of the multiple rate matching REs.

In a seventh aspect, alone or in combination with one or more of the first through sixth aspects, the configuration information indicates the rate matching pattern by indicating an index associated with a lookup table of multiple allowed rate matching patterns.

In an eighth aspect, alone or in combination with one or more of the first through seventh aspects, an SCS associated with the one of the multi-tone LP-WUS or the multi-tone LP-SS is a different SCS than an SCS associated with a BWP used to receive the downlink communication.

In a ninth aspect, alone or in combination with one or more of the first through eighth aspects, the SCS associated with the one of the multi-tone LP-WUS or the multi-tone LP-SS is a product of an integer and a maximum permissible SCS associated with a frequency range encompassing the BWP.

In a tenth aspect, alone or in combination with one or more of the first through ninth aspects, the rate matching pattern is associated with multiple rate matching RBs, and each of the multiple rate matching RBs corresponds to a tone of the one of the multi-tone LP-WUS or the multi-tone LP-SS.

In an eleventh aspect, alone or in combination with one or more of the first through tenth aspects, the configuration information indicates the rate matching pattern by indicating an index associated with a lookup table of multiple allowed rate matching patterns.

In a twelfth aspect, alone or in combination with one or more of the first through eleventh aspects, the configuration information indicates the rate matching pattern by using a bitmap indicating frequency locations of the multiple rate matching RBs.

In a thirteenth aspect, alone or in combination with one or more of the first through twelfth aspects, the rate matching pattern is associated with multiple groups of rate matching REs, and each group of rate matching REs, of the multiple groups of rate matching REs, includes a number of REs equal to a quotient of a total number of REs associated with the rate matching pattern and an integer.

In a fourteenth aspect, alone or in combination with one or more of the first through thirteenth aspects, the configuration information indicates the rate matching pattern by using a bitmap indicating frequency locations of the multiple groups of rate matching REs.

In a fifteenth aspect, alone or in combination with one or more of the first through fourteenth aspects, the configuration information further indicates the integer.

In a sixteenth aspect, alone or in combination with one or more of the first through fifteenth aspects, the rate matching pattern is associated with multiple rate matching REs.

In a seventeenth aspect, alone or in combination with one or more of the first through sixteenth aspects, the configuration information indicates the rate matching pattern by using a bitmap indicating frequency locations of the multiple rate matching REs.

In an eighteenth aspect, alone or in combination with one or more of the first through seventeenth aspects, the rate matching pattern is a dynamically scheduled rate matching pattern.

In a nineteenth aspect, alone or in combination with one or more of the first through eighteenth aspects, the rate matching pattern is one of a periodic rate matching pattern or a semi-persistent rate matching pattern.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 505) performs operations associated with rate matching for multi-tone low-power wake up signals and/or multi-tone low-power synchronization signals.

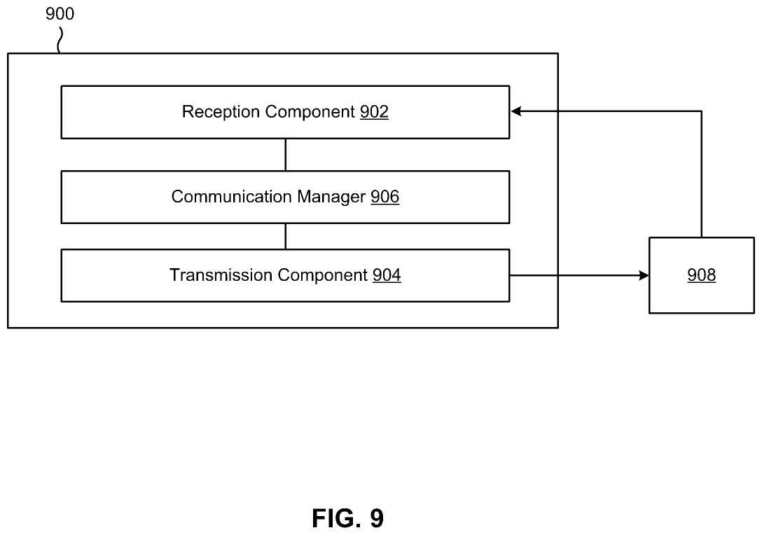

As shown in FIG. 7, in some aspects, process 700 may include transmitting, to a UE, configuration information indicating a rate matching pattern associated with one of a multi-tone LP-WUS or a multi-tone LP-SS (block 710). For example, the network node (e.g., using transmission component 904 and/or communication manager 906, depicted in FIG. 9) may transmit, to a UE, configuration information indicating a rate matching pattern associated with one of a multi-tone LP-WUS or a multi-tone LP-SS, as described above.

As further shown in FIG. 7, in some aspects, process 700 may include transmitting, to the UE, a downlink communication based at least in part on the rate matching pattern associated with the one of the multi-tone LP-WUS or the multi-tone LP-SS (block 720). For example, the network node (e.g., using transmission component 904 and/or communication manager 906, depicted in FIG. 9) may transmit, to the UE, a downlink communication based at least in part on the rate matching pattern associated with the one of the multi-tone LP-WUS or the multi-tone LP-SS, as described above.

Process 700 may include additional aspects, such as any single aspect or any combination of aspects described below and/or in connection with one or more other processes described elsewhere herein.

In a first aspect, an SCS associated with the one of the multi-tone LP-WUS or the multi-tone LP-SS is a same SCS as an SCS associated with a bandwidth part used to transmit the downlink communication.

In a second aspect, alone or in combination with the first aspect, the configuration information indicates a starting frequency location associated with the rate matching pattern and an ending frequency location associated with the rate matching pattern.

In a third aspect, alone or in combination with one or more of the first and second aspects, the configuration information includes a bitmap indicating frequency resources associated with the rate matching pattern.

In a fourth aspect, alone or in combination with one or more of the first through third aspects, the rate matching pattern is associated with multiple rate matching REs, and the multiple rate matching REs include one or more REs from each of multiple RE groups associated with the rate matching pattern.

In a fifth aspect, alone or in combination with one or more of the first through fourth aspects, the configuration information indicates the rate matching pattern by indicating frequency locations of the multiple rate matching REs based at least in part on a formula associated with an identifier related to the one of the multi-tone LP-WUS or the multi-tone LP-SS.

In a sixth aspect, alone or in combination with one or more of the first through fifth aspects, the configuration information indicates the rate matching pattern by using a bitmap indicating frequency locations of the multiple rate matching REs.

In a seventh aspect, alone or in combination with one or more of the first through sixth aspects, the configuration information indicates the rate matching pattern by indicating an index associated with a lookup table of multiple allowed rate matching patterns.

In an eighth aspect, alone or in combination with one or more of the first through seventh aspects, an SCS associated with the one of the multi-tone LP-WUS or the multi-tone LP-SS is a different SCS than an SCS associated with a BWP used to receive the downlink communication.

In a ninth aspect, alone or in combination with one or more of the first through eighth aspects, the SCS associated with the one of the multi-tone LP-WUS or the multi-tone LP-SS is a product of an integer and a maximum permissible SCS associated with a frequency range encompassing the BWP.

In a tenth aspect, alone or in combination with one or more of the first through ninth aspects, the rate matching pattern is associated with multiple rate matching RBs, and each of the multiple rate matching RBs corresponds to a tone of the one of the multi-tone LP-WUS or the multi-tone LP-SS.

In an eleventh aspect, alone or in combination with one or more of the first through tenth aspects, the configuration information indicates the rate matching pattern by indicating an index associated with a lookup table of multiple allowed rate matching patterns.

In a twelfth aspect, alone or in combination with one or more of the first through eleventh aspects, the configuration information indicates the rate matching pattern by using a bitmap indicating frequency locations of the multiple rate matching RBs.

In a thirteenth aspect, alone or in combination with one or more of the first through twelfth aspects, the rate matching pattern is associated with multiple groups of rate matching REs, and each group of rate matching REs, of the multiple groups of rate matching REs, includes a number of REs equal to a quotient of a total number of REs associated with the rate matching pattern and an integer.

In a fourteenth aspect, alone or in combination with one or more of the first through thirteenth aspects, the configuration information indicates the rate matching pattern by using a bitmap indicating frequency locations of the multiple groups of rate matching REs.

In a fifteenth aspect, alone or in combination with one or more of the first through fourteenth aspects, the configuration information further indicates the integer.

In a sixteenth aspect, alone or in combination with one or more of the first through fifteenth aspects, the rate matching pattern is associated with multiple rate matching REs.

In a seventeenth aspect, alone or in combination with one or more of the first through sixteenth aspects, the configuration information indicates the rate matching pattern by using a bitmap indicating frequency locations of the multiple rate matching REs.

In an eighteenth aspect, alone or in combination with one or more of the first through seventeenth aspects, the rate matching pattern is a dynamically scheduled rate matching pattern.

In a nineteenth aspect, alone or in combination with one or more of the first through eighteenth aspects, the rate matching pattern is one of a periodic rate matching pattern or a semi-persistent rate matching pattern.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE 120 described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE 120 described in connection with FIG. 2. In some aspects, the transmission component 804 may be co-located with the reception component 802 in a transceiver.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The reception component 802 may receive configuration information indicating a rate matching pattern associated with one of a multi-tone LP-WUS or a multi-tone LP-SS. The reception component 802 may decode a downlink communication based at least in part on the rate matching pattern associated with the one of the multi-tone LP-WUS or the multi-tone LP-SS.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node 110 described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node 110 described in connection with FIG. 2. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network node 110 described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, to a UE, configuration information indicating a rate matching pattern associated with one of a multi-tone LP-WUS or a multi-tone LP-SS. The transmission component 904 may transmit, to the UE, a downlink communication based at least in part on the rate matching pattern associated with the one of the multi-tone LP-WUS or the multi-tone LP-SS.

The number and arrangement of components shown in FIG. 9 are provided as an example. In practice, there may be additional components, fewer components, different components, or differently arranged components than those shown in FIG. 9.

Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a UE, comprising: receiving configuration information indicating a rate matching pattern associated with one of a multi-tone LP-WUS or a multi-tone LP-SS; and decoding a downlink communication based at least in part on the rate matching pattern associated with the one of the multi-tone LP-WUS or the multi-tone LP-SS.
Aspect 2: The method of Aspect 1, wherein an SCS associated with the one of the multi-tone LP-WUS or the multi-tone LP-SS is a same SCS as an SCS associated with a bandwidth part used to receive the downlink communication.
Aspect 3: The method of Aspect 2, wherein the configuration information indicates a starting frequency location associated with the rate matching pattern and an ending frequency location associated with the rate matching pattern.
Aspect 4: The method of Aspect 2, wherein the configuration information includes a bitmap indicating frequency resources associated with the rate matching pattern.
Aspect 5: The method of Aspect 2, wherein the rate matching pattern is associated with multiple rate matching REs, and wherein the multiple rate matching REs include one or more REs from each of multiple RE groups associated with the rate matching pattern.
Aspect 6: The method of Aspect 5, wherein the configuration information indicates the rate matching pattern by indicating frequency locations of the multiple rate matching REs based at least in part on a formula associated with an identifier related to the one of the multi-tone LP-WUS or the multi-tone LP-SS.
Aspect 7: The method of Aspect 5, wherein the configuration information indicates the rate matching pattern by using a bitmap indicating frequency locations of the multiple rate matching REs.
Aspect 8: The method of Aspect 2, wherein the configuration information indicates the rate matching pattern by indicating an index associated with a lookup table of multiple allowed rate matching patterns.
Aspect 9: The method of any of Aspects 1-8, wherein an SCS associated with the one of the multi-tone LP-WUS or the multi-tone LP-SS is a different SCS than an SCS associated with a BWP used to receive the downlink communication.
Aspect 10: The method of Aspect 9, wherein the SCS associated with the one of the multi-tone LP-WUS or the multi-tone LP-SS is a product of an integer and a maximum permissible SCS associated with a frequency range encompassing the BWP.
Aspect 11: The method of Aspect 10, wherein the rate matching pattern is associated with multiple rate matching RBs, and wherein each of the multiple rate matching RBs corresponds to a tone of the one of the multi-tone LP-WUS or the multi-tone LP-SS.

Aspect 12: The method of Aspect 11, wherein the configuration information indicates the rate matching pattern by indicating an index associated with a lookup table of multiple allowed rate matching patterns.

Aspect 13: The method of Aspect 11, wherein the configuration information indicates the rate matching pattern by using a bitmap indicating frequency locations of the multiple rate matching RBs.

Aspect 14: The method of Aspect 9, wherein the rate matching pattern is associated with multiple groups of rate matching REs, and wherein each group of rate matching REs, of the multiple groups of rate matching REs, includes a number of RES equal to a quotient of a total number of REs associated with the rate matching pattern and an integer.

Aspect 15: The method of Aspect 14, wherein the configuration information indicates the rate matching pattern by using a bitmap indicating frequency locations of the multiple groups of rate matching REs.

Aspect 16: The method of Aspect 14, wherein the configuration information further indicates the integer.

Aspect 17: The method of Aspect 9, wherein the rate matching pattern is associated with multiple rate matching REs.

Aspect 18: The method of Aspect 17, wherein the configuration information indicates the rate matching pattern by using a bitmap indicating frequency locations of the multiple rate matching REs.

Aspect 19: The method of any of Aspects 1-18, wherein the rate matching pattern is a dynamically scheduled rate matching pattern.

Aspect 20: The method of any of Aspects 1-19, wherein the rate matching pattern is one of a periodic rate matching pattern or a semi-persistent rate matching pattern.

Aspect 21: A method of wireless communication performed by a network node, comprising: transmitting, to a UE, configuration information indicating a rate matching pattern associated with one of a multi-tone LP-WUS or a multi-tone LP-SS; and transmitting, to the UE, a downlink communication based at least in part on the rate matching pattern associated with the one of the multi-tone LP-WUS or the multi-tone LP-SS.

Aspect 22: The method of Aspect 21, wherein an SCS associated with the one of the multi-tone LP-WUS or the multi-tone LP-SS is a same SCS as an SCS associated with a bandwidth part used to transmit the downlink communication.

Aspect 23: The method of Aspect 22, wherein the configuration information indicates a starting frequency location associated with the rate matching pattern and an ending frequency location associated with the rate matching pattern.

Aspect 24: The method of Aspect 22, wherein the configuration information includes a bitmap indicating frequency resources associated with the rate matching pattern.

Aspect 25: The method of Aspect 22, wherein the rate matching pattern is associated with multiple rate matching REs, and wherein the multiple rate matching REs include one or more REs from each of multiple RE groups associated with the rate matching pattern.

Aspect 26: The method of Aspect 25, wherein the configuration information indicates the rate matching pattern by indicating frequency locations of the multiple rate matching REs based at least in part on a formula associated with an identifier related to the one of the multi-tone LP-WUS or the multi-tone LP-SS.

Aspect 27: The method of Aspect 25, wherein the configuration information indicates the rate matching pattern by using a bitmap indicating frequency locations of the multiple rate matching REs.

Aspect 28: The method of Aspect 22, wherein the configuration information indicates the rate matching pattern by indicating an index associated with a lookup table of multiple allowed rate matching patterns.

Aspect 29: The method of any of Aspects 21-28, wherein an SCS associated with the one of the multi-tone LP-WUS or the multi-tone LP-SS is a different SCS than an SCS associated with BWP used to receive the downlink communication.

Aspect 30: The method of Aspect 29, wherein the SCS associated with the one of the multi-tone LP-WUS or the multi-tone LP-SS is a product of an integer and a maximum permissible SCS associated with a frequency range encompassing the BWP.

Aspect 31: The method of Aspect 30, wherein the rate matching pattern is associated with multiple rate matching RBs, and wherein each of the multiple rate matching RBs corresponds to a tone of the one of the multi-tone LP-WUS or the multi-tone LP-SS.

Aspect 32: The method of Aspect 31, wherein the configuration information indicates the rate matching pattern by indicating an index associated with a lookup table of multiple allowed rate matching patterns.

Aspect 33: The method of Aspect 31, wherein the configuration information indicates the rate matching pattern by using a bitmap indicating frequency locations of the multiple rate matching RBs.

Aspect 34: The method of Aspect 29, wherein the rate matching pattern is associated with multiple groups of rate matching REs, and wherein each group of rate matching REs, of the multiple groups of rate matching REs, includes a number of REs equal to a quotient of a total number of REs associated with the rate matching pattern and an integer.

Aspect 35: The method of Aspect 34, wherein the configuration information indicates the rate matching pattern by using a bitmap indicating frequency locations of the multiple groups of rate matching REs.

Aspect 36: The method of Aspect 34, wherein the configuration information further indicates the integer.

Aspect 37: The method of Aspect 29, wherein the rate matching pattern is associated with multiple rate matching REs.

Aspect 38: The method of Aspect 37, wherein the configuration information indicates the rate matching pattern by using a bitmap indicating frequency locations of the multiple rate matching REs.

Aspect 39: The method of any of Aspects 21-38, wherein the rate matching pattern is a dynamically scheduled rate matching pattern.

Aspect 40: The method of any of Aspects 21-39, wherein the rate matching pattern is one of a periodic rate matching pattern or a semi-persistent rate matching pattern.

Aspect 41: An apparatus for wireless communication at a device, comprising a processor; memory coupled with the processor; and instructions stored in the memory and executable by the processor to cause the apparatus to perform the method of one or more of Aspects 1-40.

Aspect 42: A device for wireless communication, comprising a memory and one or more processors coupled to the memory, the one or more processors configured to perform the method of one or more of Aspects 1-40.

Aspect 43: An apparatus for wireless communication, comprising at least one means for performing the method of one or more of Aspects 1-40.

Aspect 44: A non-transitory computer-readable medium storing code for wireless communication, the code comprising instructions executable by a processor to perform the method of one or more of Aspects 1-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-40.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive configuration information indicating a rate matching pattern associated with one of a multi-tone low-power wake up signal (LP-WUS) or a multi-tone low-power synchronization signal (LP-SS); and
decode a downlink communication based at least in part on the rate matching pattern associated with the one of the multi-tone LP-WUS or the multi-tone LP-SS.

2. The UE of claim 1, wherein a subcarrier spacing (SCS) associated with the one of the multi-tone LP-WUS or the multi-tone LP-SS is a same SCS as an SCS associated with a bandwidth part used to receive the downlink communication.

3. The UE of claim 2, wherein the configuration information indicates a starting frequency location associated with the rate matching pattern and an ending frequency location associated with the rate matching pattern.

4. The UE of claim 2, wherein the configuration information includes a bitmap indicating frequency resources associated with the rate matching pattern.

5. The UE of claim 2, wherein the rate matching pattern is associated with multiple rate matching resource elements (REs), and wherein the multiple rate matching REs include one or more REs from each of multiple RE groups associated with the rate matching pattern.

6. The UE of claim 5, wherein the configuration information indicates the rate matching pattern by indicating frequency locations of the multiple rate matching REs based at least in part on a formula associated with an identifier related to the one of the multi-tone LP-WUS or the multi-tone LP-SS.

7. The UE of claim 5, wherein the configuration information indicates the rate matching pattern by using a bitmap indicating frequency locations of the multiple rate matching REs.

8. The UE of claim 2, wherein the configuration information indicates the rate matching pattern by indicating an index associated with a lookup table of multiple allowed rate matching patterns.

9. The UE of claim 1, wherein a subcarrier spacing (SCS) associated with the one of the multi-tone LP-WUS or the multi-tone LP-SS is a different SCS than an SCS associated with a bandwidth part (BWP) used to receive the downlink communication.

10. The UE of claim 9, wherein the SCS associated with the one of the multi-tone LP-WUS or the multi-tone LP-SS is a product of an integer and a maximum permissible SCS associated with a frequency range encompassing the BWP.

11. The UE of claim 10, wherein the rate matching pattern is associated with multiple rate matching resource blocks (RBs), and wherein each of the multiple rate matching RBs corresponds to a tone of the one of the multi-tone LP-WUS or the multi-tone LP-SS.

12. The UE of claim 11, wherein the configuration information indicates the rate matching pattern by indicating an index associated with a lookup table of multiple allowed rate matching patterns.

13. The UE of claim 11, wherein the configuration information indicates the rate matching pattern by using a bitmap indicating frequency locations of the multiple rate matching RBs.

14. The UE of claim 9, wherein the rate matching pattern is associated with multiple groups of rate matching resource elements (REs), and wherein each group of rate matching REs, of the multiple groups of rate matching REs, includes a number of REs equal to a quotient of a total number of REs associated with the rate matching pattern and an integer.

15. The UE of claim 14, wherein the configuration information indicates the rate matching pattern by using a bitmap indicating frequency locations of the multiple groups of rate matching REs.

16. The UE of claim 14, wherein the configuration information further indicates the integer.

17. The UE of claim 9, wherein the rate matching pattern is associated with multiple rate matching resource elements (REs).

18. The UE of claim 17, wherein the configuration information indicates the rate matching pattern by using a bitmap indicating frequency locations of the multiple rate matching REs.

19-26. (canceled)

27. A method of wireless communication performed by a user equipment (UE), comprising:
receiving configuration information indicating a rate matching pattern associated with one of a multi-tone low-power wake up signal (LP-WUS) or a multi-tone low-power synchronization signal (LP-SS); and
decoding a downlink communication based at least in part on the rate matching pattern associated with the one of the multi-tone LP-WUS or the multi-tone LP-SS.

28. The method of claim 27, wherein the rate matching pattern is a dynamically scheduled rate matching pattern.

29-30. (canceled)
